(19) United States
(12) Patent Application Publication
(10) Pub. No.: US 2016/0283864 A1
(43) Pub. Date: Sep. 29, 2016

(54) SEQUENTIAL IMAGE SAMPLING AND STORAGE OF FINE-TUNED FEATURES

(71) Applicant: QUALCOMM Incorporated, San Diego, CA (US)

(72) Inventor: Regan Blythe TOWAL, San Diego, CA (US)

(21) Appl. No.: 14/845,236

(22) Filed: Sep. 3, 2015

Related U.S. Application Data
(60) Provisional application No. 62/139,220, filed on Mar. 27, 2015.

(51) Int. Cl. G06N 99/00

(52) U.S. Cl. CPC G06N 99/005

(57) ABSTRACT

Feature extraction includes determining a reference model for feature extraction and fine-tuning the reference model for different tasks. The method also includes storing a set of weight differences calculated during the fine-tuning. Each set may correspond to a different task.

### CROSS-REFERENCE TO RELATED APPLICATION

This application claims the benefit under 35 U.S.C. §119(e) to U.S. Provisional Patent Application No. 62/139,220 entitled “SIMULTANEOUS LEARNING OF TASK AND FINE-TUNED FEATURES” filed on Mar. 27, 2015, the disclosure of which is expressly incorporated herein by reference in its entirety.

### BACKGROUND

1. Field

Certain aspects of the present disclosure generally relate to machine learning and, more particularly, to improving systems and methods of feature extraction.

2. Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect of the present disclosure, a method of feature extraction is disclosed. The method includes determining a reference model for feature extraction. The method also includes fine-tuning the reference model for multiple different tasks. The method further includes storing a set of weight differences calculated during the fine-tuning. Each set may correspond to a different task.

Another aspect of the present disclosure is directed to an apparatus including means for determining a reference model for feature extraction. The apparatus also includes means for fine-tuning the reference model for multiple different tasks. The apparatus further includes means for storing a set of weight differences calculated during the fine-tuning. Each set may correspond to a different task.

In another aspect of the present disclosure, a computer program product for feature extraction is disclosed. The computer program product has a non-transitory computer-readable medium with non-transitory program code recorded thereon. The program code is executed by a processor and includes program code to determine a reference model for feature extraction. The program code also includes program code to fine-tune the reference model for multiple different tasks. The program code further includes program code to store a set of weight differences calculated during the fine-tuning. Each set may correspond to a different task.

Another aspect of the present disclosure is directed to an apparatus for feature extraction having a memory and one or more processors coupled to the memory. The processor(s) is configured to determine a reference model for feature extraction. The processor(s) is also configured to fine-tune the reference model for multiple different tasks. The processor(s) is further configured storing a set of weight differences calculated during the fine-tuning. Each set may correspond to a different task.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 is a block diagram illustrating a general architecture for a conventional feature extractor.

FIG. 7 is block diagram illustrating an exemplary architecture for a feature extraction apparatus in accordance with aspects of the present disclosure.

FIGS. 8A and 8B are block diagrams illustrating exemplary architectures for feature extraction apparatuses in accordance with aspects of the present disclosure

FIG. 9 illustrates a method for feature extraction according to aspects of the present disclosure.

FIG. 10 illustrates a flow diagram for feature extraction according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some networks, an image may be masked and processed to determine specific objects in the image. Still, in other networks, different areas of an image may be sampled until a desired output is received. For example, a network may begin by sampling a first region and determining whether the network should sample other regions of the image to ascertain the content of the image. As an example, the first region may include the leg of a beach chair and sand. Thus, the network determines that a second region of the image should be sampled to determine whether the image includes an ocean and/or other objects associated with the beach. That is, the second region is selected based on the content of the first region.

The sequential sampling of an image is similar to a human's visual sampling. That is, in most cases, humans sequentially sample areas of an image until a certain confidence is reached for the content of the image. Thus, when sampling a given region, the network determines the content of the given region. Furthermore, the network also determines a subsequent region that should be sampled to gather additional information that is relevant to the task, such as recognizing a face. More specifically, in a scene with various objects and/or high detail, it is desirable to sequentially sample regions of the scene rather than sampling the entire scene at once.

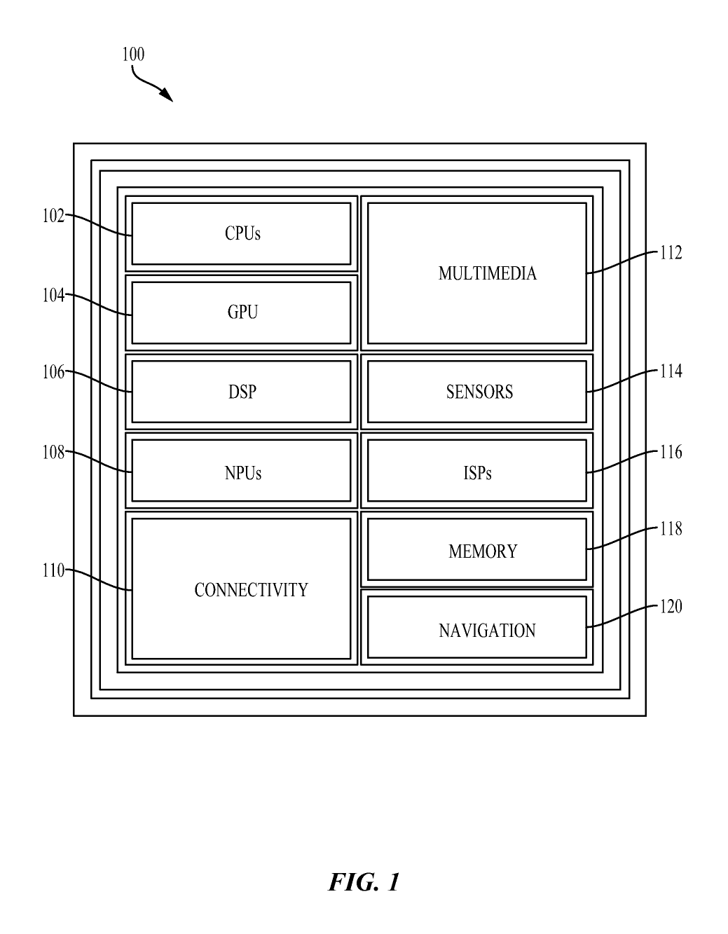

FIG. 1 illustrates an example implementation of the aforementioned feature extraction via sequential sampling using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108 or in a dedicated memory block 118. Instructions executed at the general-purpose processor 102 may be loaded from a program memory associated with the CPU 102 or may be loaded from a dedicated memory block 118.

The SOC 100 may also include additional processing blocks tailored to specific functions, such as a graphics processing unit (GPU) 104, a digital signal processor (DSP) 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. The SOC 100 may also include a sensor processor 114, image signal processors (ISPs), and/or navigation 120, which may include a global positioning system. The SOC may be based on an ARM instruction set.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for determining a reference model for feature extraction. The instructions loaded into the general-purpose processor 102 may also comprise code for fine-tuning the reference model for different tasks. The instructions loaded into the general-purpose processor 102 may also comprise code for storing a set of weight differences calculated during the fine-tuning.

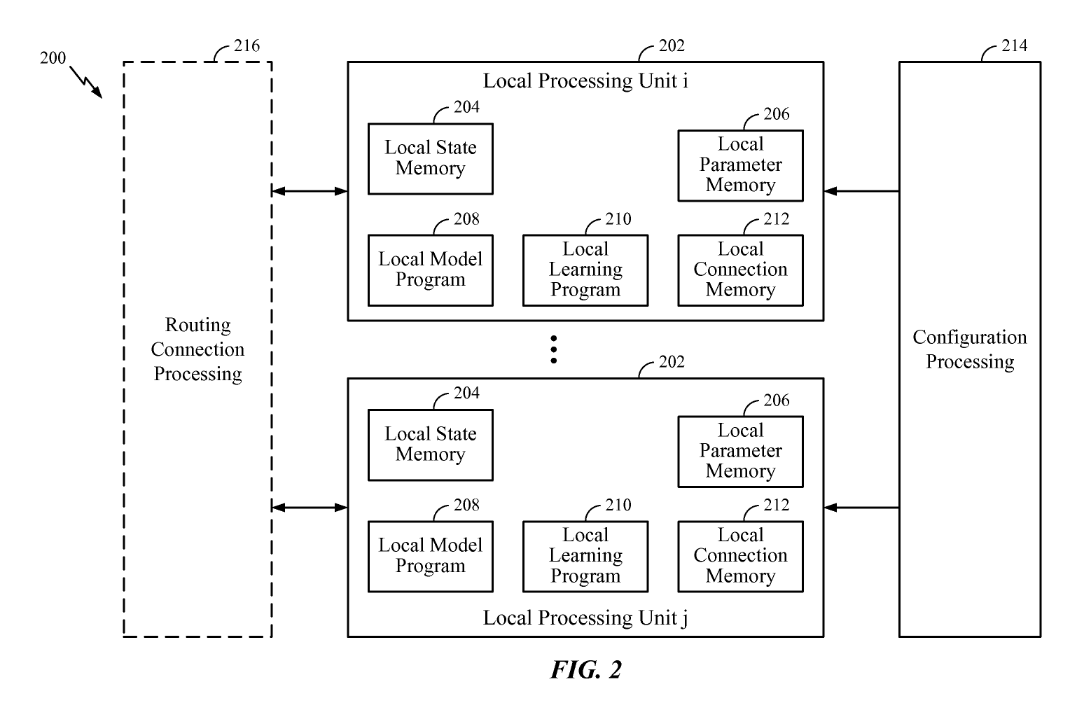

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

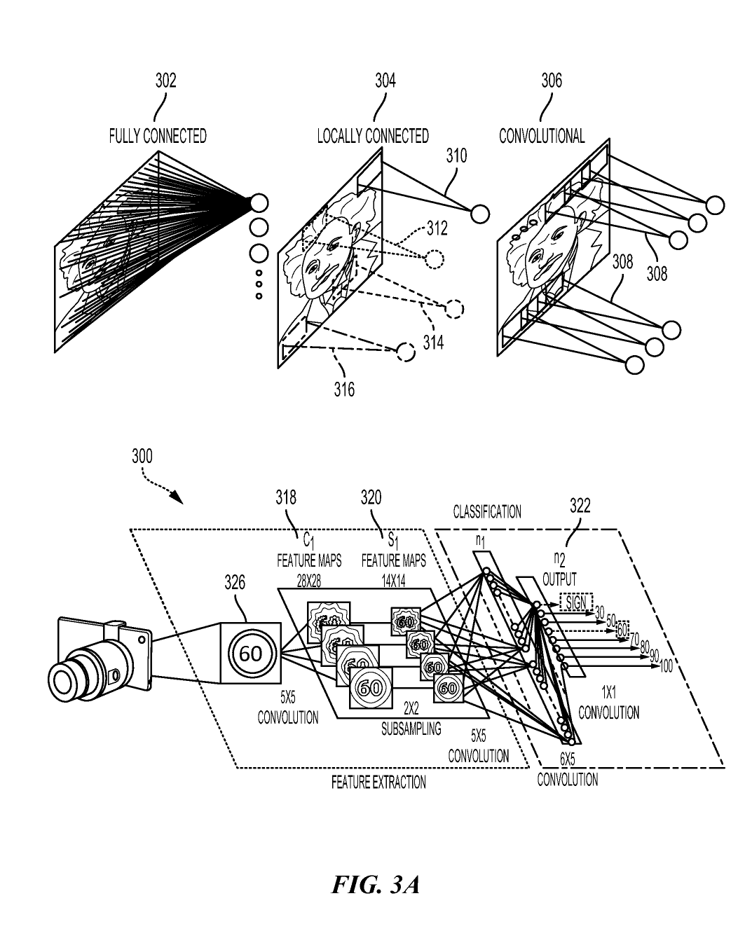

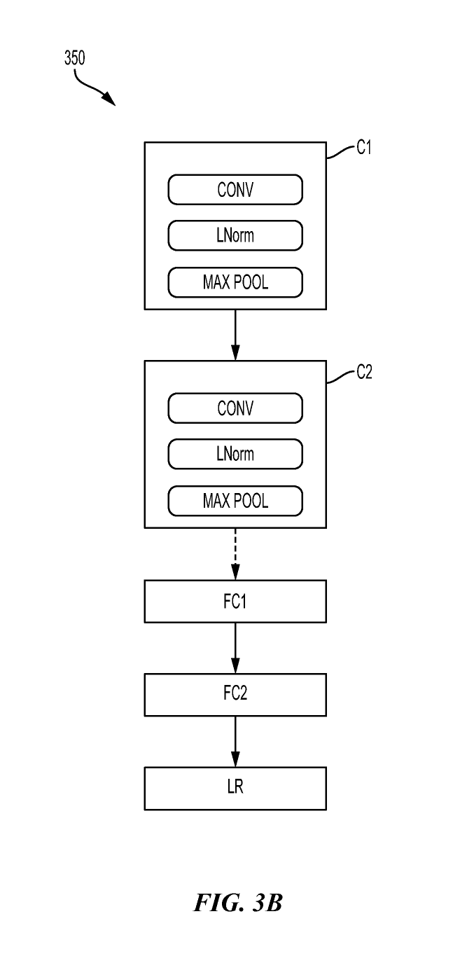

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

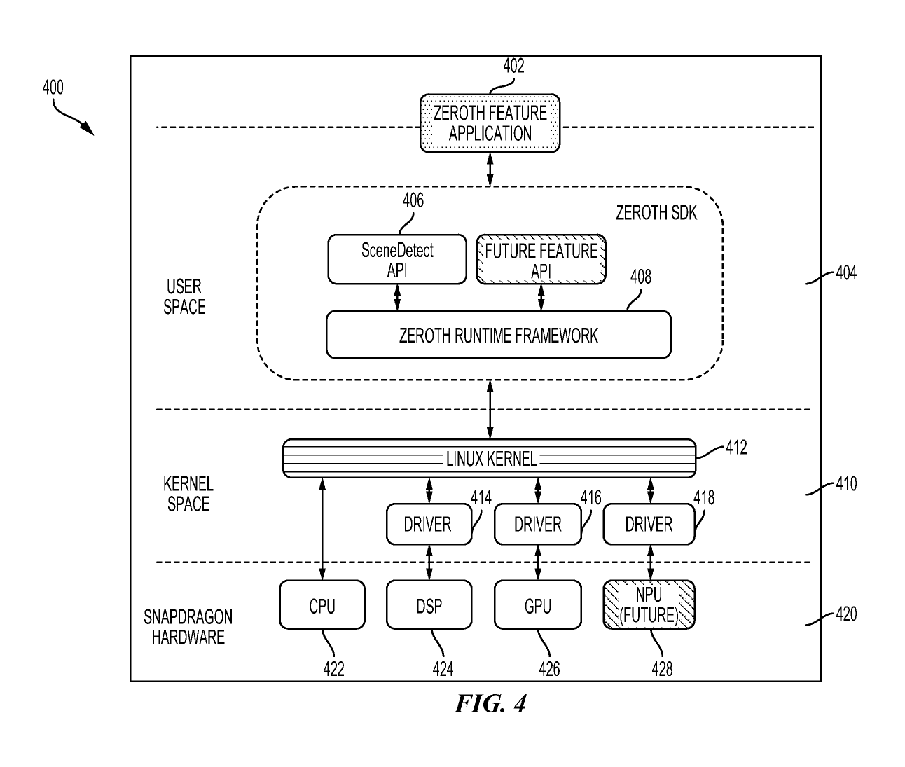

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

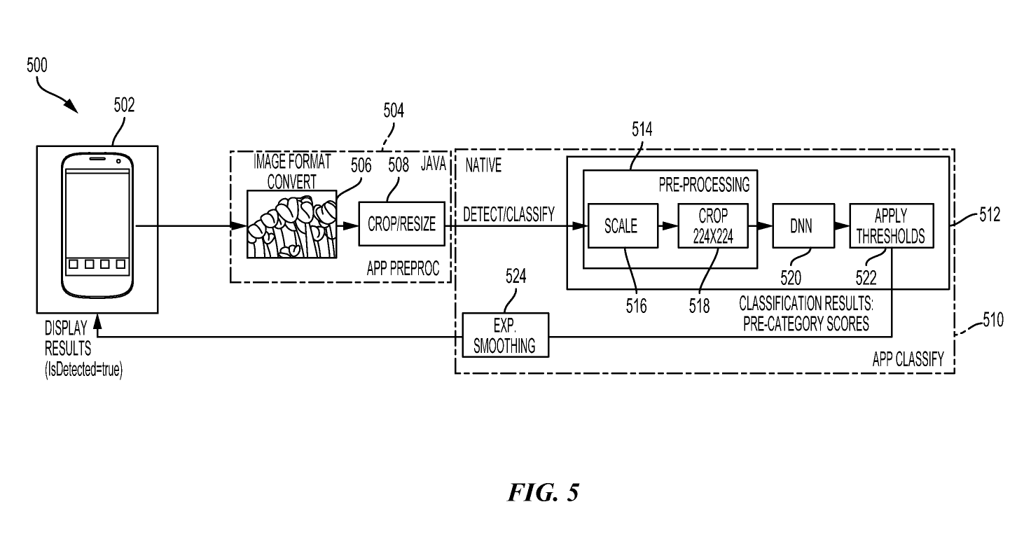

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

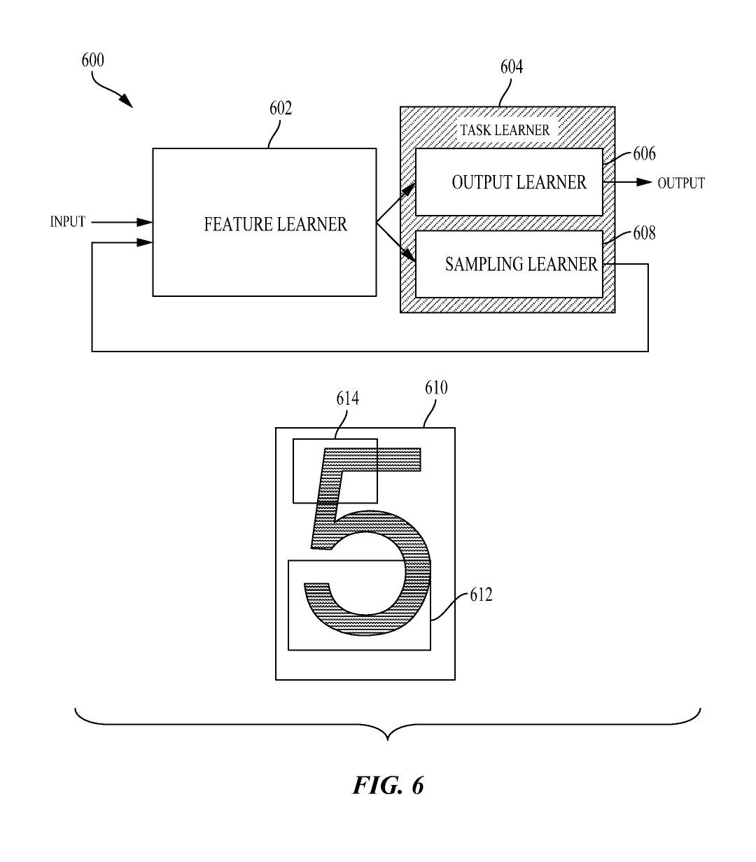

FIG. 6 is a block diagram illustrating a general architecture for a feature extractor 600. The architecture may include a feature learner 602 and a task learner 604. The task learner 604 may include an output learner 606, such as a classifier, and a sampling learner 608, such as a localizer model.

In conventional systems, the feature extractor 600 is specified to learn features from the input, such as an image. Specifically, the feature learner 602 may receive an input, such as an image or an audio selection, and extracts features from the input. The extracted features are input to the task learner 604 to perform a task. Exemplary tasks may include object recognition, face recognition, speech recognition, scene recognition, and/or other tasks. In most cases, the output learner 606 determines the content of the extracted feature(s). For example, the output learner 606 may classify an extracted feature as an image of a beach ball. Additionally, the sampling learner 608 determines a subsequent region of the input to extract (i.e., sample). That is, based on the extracted feature(s), the sampling learner 608 instructs the feature learner 602 to extract one or more features from another region of the input.

As an example, in a conventional system, an image 610 of the number five may be input to the feature learner 602. In this example, the feature learner 602 may extract features from a lower portion 612 of the image 610 at one or more resolutions. The extracted lower portion 612 is input to the output learner 606 and the sampling learner 608. Based on the input, the output learner 606 may classify the image as being either the number three, the number five, or the number nine. Specifically, in this example, the output learner 606 may classify the image as being one of the aforementioned numbers because three, five, and nine are the only number with an open curved bottom. Still, in this example, a confidence of the output learner 606 for a specific number is low because, based on the sampled region, the image 610 may be one of three numbers.

Thus, because the output learner 606 may not have a high confidence as to the specific number that is in the image 610, the sampling learner 608 may instruct the feature learner 602 to extract the upper left corner 614 of the image 610. In this example, the upper left corner 614 is unique between the numbers three, five, and nine. Thus, based on the first sample of the lower portion 612, the sampling learner 608 determines that sampling the upper left corner 614 of the image 610 may yield the features that improve the classification of the image 610. The determination of which subsequent region for feature extraction may be based on weights determined from reinforcement learning.

Based on the features from the upper left corner 614 of the image 610 (i.e., the second region of the image), the output learner 606 may classify the image 610 as the number five. In this example, based on the features from the upper left corner 614 of the image 610, the confidence of the classification from the output learner 606 may be above a threshold. Therefore, because the confidence of the classification is above the threshold, the sampling learner 608 may determine that no other regions of the image 610 should be sampled.

As previously discussed, based on the current region, the conventional network determines a subsequent region for extraction based on weights determined from reinforcement learning. Still, the conventional network may determine all the weights at once. That is, the conventional network may simultaneously train tasks and features. Thus, the training time for the conventional network is increased. Accordingly, it is desirable to improve the performance of the network by using fine-tuned features from pre-trained domain-specific models.

That is, specific models may be pre-trained to determine specific features of an input that may be desirable for feature extraction. For example, if the input is an image of a nature scene, various pre-trained models, such as models trained from Imagenet, may be used to extract the relevant features from a nature scene. Thus, rather than simultaneously training tasks and features, a pre-trained model may be specified for a network and the features of the pre-trained model may be fine-tuned. Fine-tuning may be performed by back-propagation to adjust the weights in the model. The model may be a deep convolutional network (DCN).

In the present configuration, a pre-trained reference model is used and fine-tuned by the reinforcement learning rather than learning the features from weights that are initially set to zero. It may be desirable to use pre-learned features to reduce the training time by specifying that the early layers of the network produce relevant output at the beginning of training.

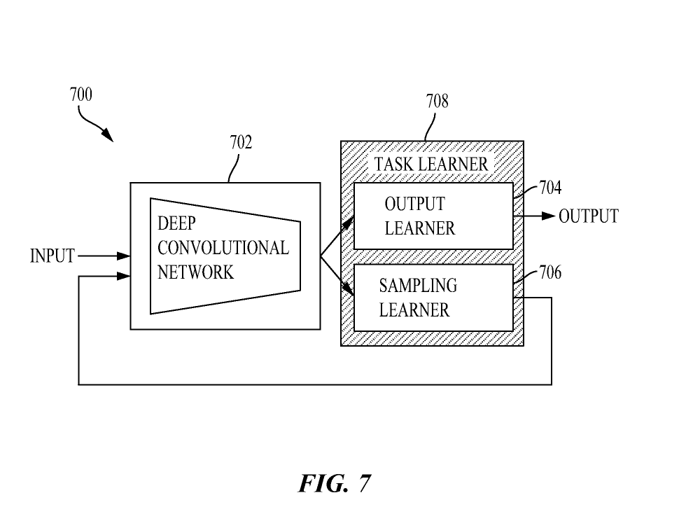

FIG. 7 is a block diagram illustrating an exemplary architecture for a feature extractor 700 in accordance with aspects of the present disclosure. Referring to FIG. 7, a reference model 702, such as a deep convolutional network, may be configured as a feature learner. Although, a deep convolutional network is shown in the exemplary architecture of FIG. 7, the present disclosure is not so limited and other machine learning networks may be used.

In one configuration, rather than simultaneously training tasks and features, the reference model 702 may be configured using a pre-trained reference model. For example, in some aspects, the reference model may be pre-trained on a data set, such as Imagenet or other pre-trained data sets. The features may be fine-tuned, for example using back propagation, according to a task to be performed. By using the pre-trained reference model, initial features may provide information for the content of the input and the training time may be decreased.

The feature extractor 700 may also include a task learner 708, which may include an output learner 704 and a sampling learner 706. The output learner 704 may classify the features extracted from the reference model 702. Furthermore, the sampling learner 706 may be configured to determine a next portion of the input to sample. In some aspects, the sampling learner 706 may be configured as an attention model or other localization model for determining sampling information relative to the input. The sampling information may be supplied as feedback to the reference model 702.

In some cases, different tasks may be specified for a network. For example, a first task may be to classify a dog or a cat and the second task may be to classify a man or a woman. Thus, the weights learned for a first task may be different from the weights learned for a second task. Accordingly, the change in weight will differ from the weights of the pre-trained reference model. Still, the change in weight from the weights of the pre-trained reference model may be small in comparison to the overall weights of the network.

Thus, fine-tuning a standard set of features, such as image features, allows the fine-tuned features to be stored as a delta from the original set according to the task, such as scene recognition, object recognition, and/or face recognition. Storing the delta weights from a standard set rather than the full value for each task model may reduce the number of bits for storage and/or enable sparse storage by only storing the non-zero deltas.

In one configuration, the network stores the base model, such as the original pre-trained deep convolutional network, and the change in weight between the original pre-trained deep convolutional network and a deep convolutional network trained for a specific task. That is, rather than storing a large network trained for each task, aspects of the present disclosure are directed to reducing the amount of data that is stored by storing the original pre-trained deep convolutional network and the deep convolutional network delta weights for each task. The change in weight may be referred to as the delta weight. Moreover, the change in weight for the deep convolutional network may be referred to as a deep convolutional network delta weight.

For example, in a conventional network, a first deep convolutional network is specified for facial recognition and a second deep convolutional network is specified for scene recognition. The first deep convolutional network and the second deep convolutional network are different deep convolutional networks that have been trained and fine-tuned using different data. Moreover, a conventional network would store both the first deep convolutional network and the second deep convolutional network. Still, it may be undesirable to store two deep convolutional networks due to memory constraints. Thus, in one configuration, a pre-trained deep convolutional network is stored and the deep convolutional network delta weights of each task (e.g., facial recognition and scene recognition) are stored.

Additionally, or alternatively, a localizer network may be stored. The localizer determines a subsequent region for extraction based on the classification of a current region. Additionally, the localizer may be task dependent. For example, a subsequent region to search differs based on whether a classified object is a face or a number. In one configuration, a bottom-up localizer may be used for features that may be general amongst inputs, such as images or audio.

For example, the bottom-up localizer may be used to search for a specific contrast in an image. In this example, the location policy may be specified to extract features from regions of an image with a specific contrast, such as a high contrast. Furthermore, the bottom-up localizer may be fine-tuned, via reinforcement learning, for specific tasks. The fine-tuning may change the weights of the bottom-up localizer based on the specific task. Thus, in one configuration, rather than storing a localizer that is specific for each task, the original bottom-up localizer is stored along with the localizer delta weights specified for each task.

Furthermore, a classifier may be different for each task. For example, a classifier for digits may classify ten digits while a classifier for faces may include hundreds of faces. Therefore, a separate classifier may be stored for each task.

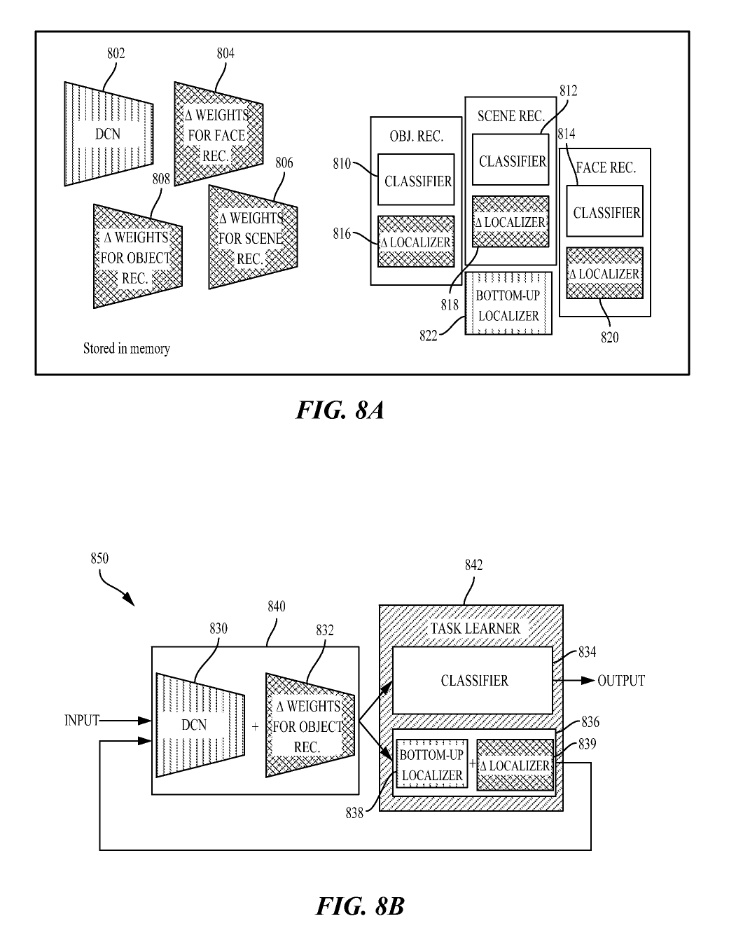

As shown in FIG. 8A, task-specific differences from the pre-trained reference model may be stored. That is, rather than storing a complete model for each different task, a pre-trained reference model 802 may be stored along with the deep convolutional network delta weight differences 804-808 for each of the different tasks. Furthermore, a classifier 810-814 and localizer 816-820 are stored for each task. Finally, a bottom-up localizer 822 may be stored for the network. The task-specific differences may include task specific items such as deep convolutional network delta weights, localizer delta weights, and classifiers.

For example, as shown in the FIG. 8A, the pre-trained reference model 802 may be stored along with face recognition task delta weights 804, object recognition task delta weights 808, and scene recognition task delta weights 806. It should be noted that the type and number of tasks is merely exemplary and not limiting.

In some aspects, the reference model may comprise a localization model. Similarly, the pre-trained localization reference model may be stored along with localization delta weights for each of the different tasks. As shown, for example, in FIG. 8A, the localization reference model may be configured as a bottom-up localizer 822. Furthermore, object recognition localizer delta weights 816, scene recognition localizer delta weights 818, and/or face recognition localizer delta weights 820 may be stored for each task. Finally, an object recognition classifier 810, a scene recognition classifier 812, and/or a face recognition localizer classifier 814 may be stored for each task.

FIG. 8B illustrates an example of a feature extractor 850 that is specified to use the stored task-related items based on a specified task. As shown in FIG. 8B, the feature extractor 850 includes a feature learner 840. The feature learner 840 may include a feature extraction reference model 830 that loads feature weights 832 based on a given task, such as facial recognition or object recognition. Additionally, the feature extractor 850 includes a task learner 842. The task learner 842 includes a classifier 834 and localizer models 836 that are loaded based on the given task. The localizer models 836 include a localizer reference model, such as bottom-up localizer 838, and localizer delta weights 839. As previously discussed, the feature weights 832, classifier 834, and localizer delta weights 839 may be loaded from the stored task-related items based on a given task.

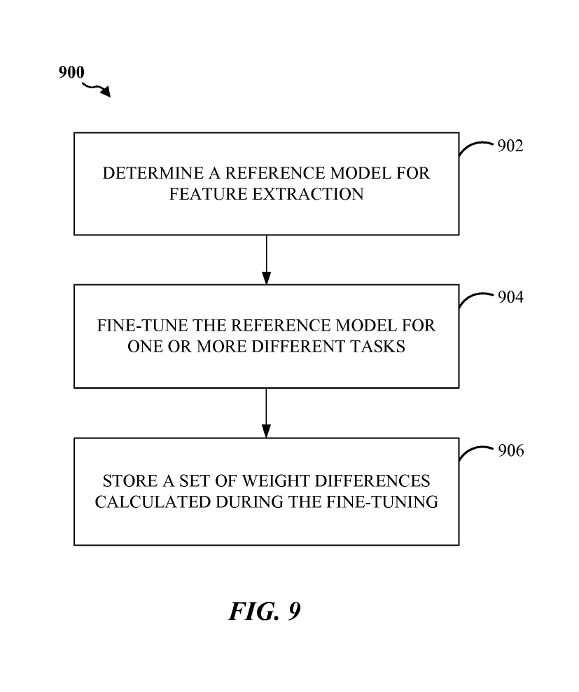

FIG. 9 illustrates a method 900 for feature extraction. In block 902, the process determines a reference model for feature extraction. The reference model may comprise a localization (attention) model. In some aspects, the reference model may comprise a feature learning model.

In block 904, the process fine-tunes the reference model for different tasks. In some aspects, fine-tuning may comprise applying a task specific classifier.

Furthermore, in block 906, the process stores a set of weight differences calculated during the fine-tuning. Each set of weight differences may correspond to a different task. In some aspects, the process includes storing only non-zero weight differences.

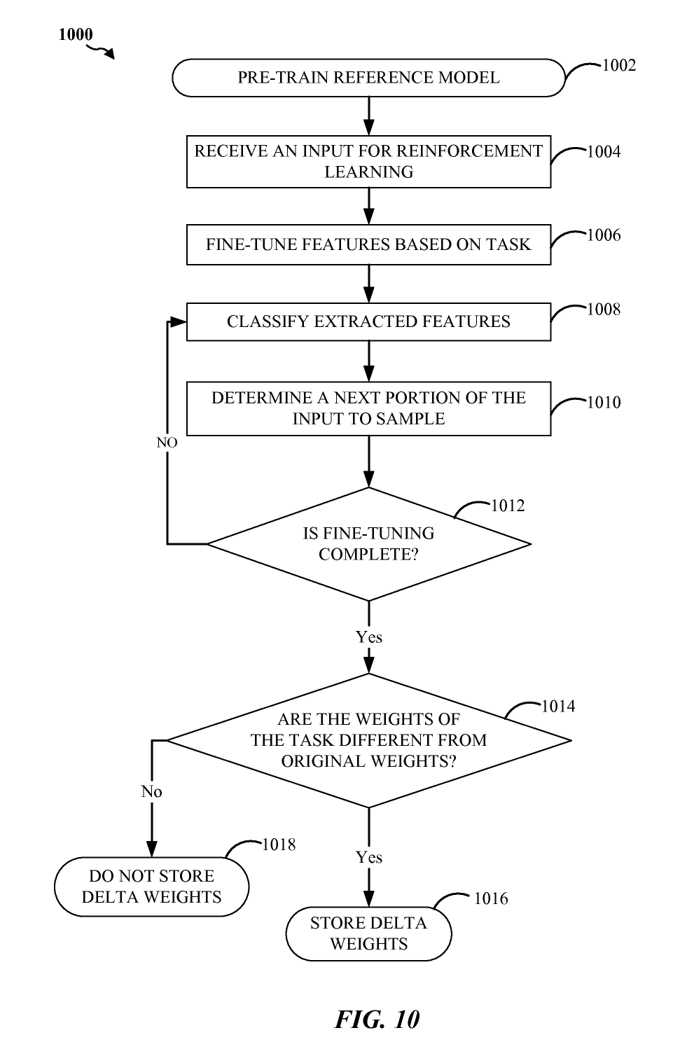

FIG. 10 illustrates a flow diagram 1000 for feature extraction according to an aspect of the present disclosure. At block 1002, a reference model, such as a deep convolutional network (or other type of machine learning model), is pre-trained on a data set. At block 1004, the reference model receives an input for reinforcement learning. Additionally, at block 1006, the input is used to fine-tune the pre-trained features of the reference model according to a task to be performed. Back-propagation may be used to fine-tune the reference model.

At block 1008, an output learner classifies the features extracted from the reference model. Furthermore, at block 1010, a sampling learner determines a next portion of the input to sample. At block 1012, the reference model determines whether fine-tuning is complete. For example, performance levels, memory storage, or processing efficiency could be considered to determine whether fine-tuning is complete.

If the fine-tuning is not complete, the reference model continues to be fine-tuned with the features extracted from the input (block 1008). Alternatively, if fine-tuning is complete, for each task specified for a network, at block 1014, the network determines if the weights learned for a first task are different from the weights learned for a second task. If the weights of the task are different, the fine-tuned features are stored as delta weights from the original set (block 1016). If the weights are not different, the delta weights are not stored (block 1018).

In one configuration, a machine learning model, such as a DCN, is configured for determining a reference model for feature extraction, fine-tuning the reference model for different tasks and/or storing a set of weight differences calculated during the fine-tuning. The model includes a determining means, means for fine-tuning, and/or storing means. In one aspect, the determining means, fine-tuning means, and/or storing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the deep convolutional network based upon desired one or more functional features of the network, and develop the one or more functional features towards the desired functional features as the determined parameters are further adapted, tuned and updated.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of feature extraction, comprising:
determining a reference model for feature extraction;
fine-tuning the reference model for a plurality of different tasks; and
storing a set of weight differences calculated during the fine-tuning, each set corresponding to a different task.

2. The method of claim 1, in which the reference model comprises a localization model.

3. The method of claim 1, in which the reference model comprises a feature learning model.

4. The method of claim 1, in which the storing comprises storing only non-zero weight differences.

5. The method of claim 1, in which the fine-tuning comprises applying a task specific classifier.

6. An apparatus for feature extraction, comprising:
a memory; and
at least one processor coupled to the memory, the at least one processor configured:
to determine a reference model for feature extraction;
to fine-tune the reference model for a plurality of different tasks; and
to store a set of weight differences calculated during fine-tuning, each set corresponding to a different task.

7. The apparatus of claim 6, in which the reference model comprises a localization model.

8. The apparatus of claim 6, in which the reference model comprises a feature learning model.

9. The apparatus of claim 6, in which the at least one processor is further configured to store only non-zero weight differences.

10. The apparatus of claim 6, in which the at least one processor is further configured to apply a task specific classifier.

11. An apparatus for feature extraction, comprising:
means for determining a reference model for feature extraction;
means for fine-tuning the reference model for a plurality of different tasks; and
means for storing a set of weight differences calculated during fine-tuning, each set corresponding to a different task.

12. The apparatus of claim 11, in which the reference model comprises a localization model.

13. The apparatus of claim 11, in which the reference model comprises a feature learning model.

14. The apparatus of claim 11, in which the means for storing stores only non-zero weight differences.

15. The apparatus of claim 11, further including means for applying a task specific classifier.

16. A non-transitory computer-readable medium having encoded thereon program code to be executed by a processor, the program code comprising:
program code to determine a reference model for feature extraction;
program code to fine-tune the reference model for a plurality of different tasks; and
program code to store a set of weight differences calculated during fine-tuning, each set corresponding to a different task.

17. The computer-readable medium of claim 16, in which the reference model comprises a localization model.

18. The computer-readable medium of claim 16, in which the reference model comprises a feature learning model.

19. The computer-readable medium of claim 16, further comprising program code to store only non-zero weight differences.

20. The computer-readable medium of claim 16, further comprising program code to apply a task specific classifier.
